(19) United States
(12) Patent Application Publication
(10) Pub. No.: US 2009/0296979 A1
(43) Pub. Date: Dec. 3, 2009

(54) Speaker

(75) Inventors: Tomohiko Kamimura, Osaka (JP); Hideo Yuasa, Qingdao City (JP)

Correspondence Address: BACON & THOMAS, PLLC, 625 SLATERS LANE, FOURTH FLOOR, ALEXANDRIA, VA, 22314-1176, US

(73) Assignee: Hosiden Corporation, Osaka (JP)

(21) Appl. No.: 12/457,133

(22) Filed: Jun. 2, 2009

(30) Foreign Application Priority Data
Jun. 2, 2008 (JP) 2008-144046
Jun. 3, 2008 (JP) 2008-146061

(51) Int. Cl. H04R 9/06

(52) U.S. Cl. 381/412

(57) ABSTRACT

The invention provides a speaker comprising: a magnetic circuit 3; a vibration system 4 in which a diaphragm 22 is attached to a voice coil 21; and a frame 2 which supports the magnetic circuit 3 and the vibration system 4. The voice coil 21 is placed in a magnetic gap 17. By taking advantage of the characteristics of a plastic magnet that it can be easily processed into a desired shape, the magnetic circuit 3 is configured by: a plastic magnet 16 having a T-like section shape; and a yoke 10 which is continuously disposed in a bottom portion side and periphery of the plastic magnet 16. The number of components of the magnetic circuit, which conventionally has the three-piece structure, is reduced, so that the mass productivity of a small and thin speaker can be enhanced.

### TECHNICAL FIELD

The present invention relates to a small and thin speaker which can be used in a portable telephone or the like.

### BACKGROUND ART

Conventionally, a speaker (dynamic speaker) which uses a plastic magnet in a magnetic circuit is known in, for example, Patent Literature 1. However, the component configuration and assembling of the magnetic circuit of such a speaker are identical with those of a speaker which uses a usual metal (ferrite, alnico, rear earth, or the like) magnet. Irrespective of the kind of magnet, a magnetic circuit is assembled by bonding together three components, or a magnet, a yoke, and a pole piece.

### PRIOR ART LITERATURE

### [Patent Literature]

[Patent Literature 1] Japanese Patent Application Laying-Open No. 2000-32589

### SUMMARY OF THE INVENTION

### [Problem to be Solved by the Invention]

A conventional speaker has a problem in that an adhesive agent which is used in the assembling of a magnetic circuit exerts a very large influence, and hence the mass productivity is hardly enhanced.

The invention has been conducted in view of the problem. It is an object of the invention to provide a small and thin speaker which uses the characteristics of a plastic magnet that it can be easily processed into a desired shape, and which therefore has a high mass productivity.

### [Means for Solving the Problem]

In order to attain the object, the speaker of the invention is a speaker comprising: a magnetic circuit; a vibration system in which a diaphragm is attached to a voice coil; and a frame which supports the magnetic circuit and the vibration system, the voice coil being placed in a magnetic gap, wherein the magnetic circuit is configured by: a plastic magnet having a T-like section shape; and a yoke which is continuously disposed in a bottom portion side and periphery of the plastic magnet. The magnet itself plays a role of a pole piece. As compared with a conventional magnetic circuit having the three-piece structure, the magnet which occupies a smaller space, and which has a larger volume can be used. The magnetic circuit, which conventionally has the three-piece structure, is configured by a two-piece structure, i.e., the number of components is reduced while the driving force of the voice coil is enhanced.

In the invention, preferably, a top face of the plastic magnet is formed as a concave face, and a middle portion of the diaphragm is formed into an inverted dome-like shape.

In the invention, preferably, a tubular portion which is raised from the yoke on the bottom portion side of the plastic magnet, by a burling process, and a through hole through which the tubular portion is to be passed to a center portion of the plastic magnet are disposed, and the plastic magnet is coupled with the yoke by applying a collapsing process on a tip end portion of the tubular portion.

### [Effects of the Invention]

According to the invention, the magnetic circuit is configured by: the plastic magnet having a T-like section shape; and the yoke which is continuously disposed in the bottom portion side and periphery of the plastic magnet. Therefore, the number of components of the magnetic circuit, which conventionally has the three-piece structure, is reduced, so that the mass productivity of a small and thin speaker can be enhanced.

According to the invention, the top face of the plastic magnet is formed as a concave face, and a middle portion of the diaphragm is formed into an inverted dome-like shape. Therefore, a sufficient amplitude can be ensured in the vibration system, and further thinning of a small and thin speaker can be realized without impairing the acoustic performance.

According to the invention, the tubular portion which is raised from the yoke on the bottom portion side of the plastic magnet, by a burling process, and the through hole through which the tubular portion is to be passed to a center portion of the plastic magnet are disposed, and the plastic magnet is coupled with the yoke by applying a collapsing process on a tip end portion of the tubular portion. Therefore, the magnetic circuit can be assembled without using an adhesive agent, and the mass productivity of a small and thin speaker can be further enhanced.

### BRIEF DESCRIPTION OF THE DRAWINGS

FIG. 1 is a sectional view of a speaker of an embodiment of the invention.

FIG. 2 is a plan view of a state where a diaphragm of the speaker of the embodiment of the invention is made transparent.

### MODE FOR CARRYING OUT THE INVENTION

Hereinafter, an embodiment of the invention will be described with reference to the drawings.

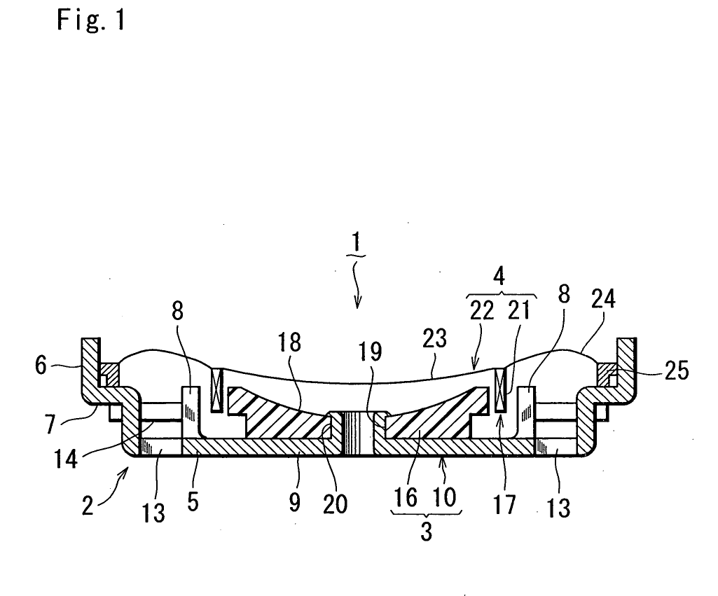

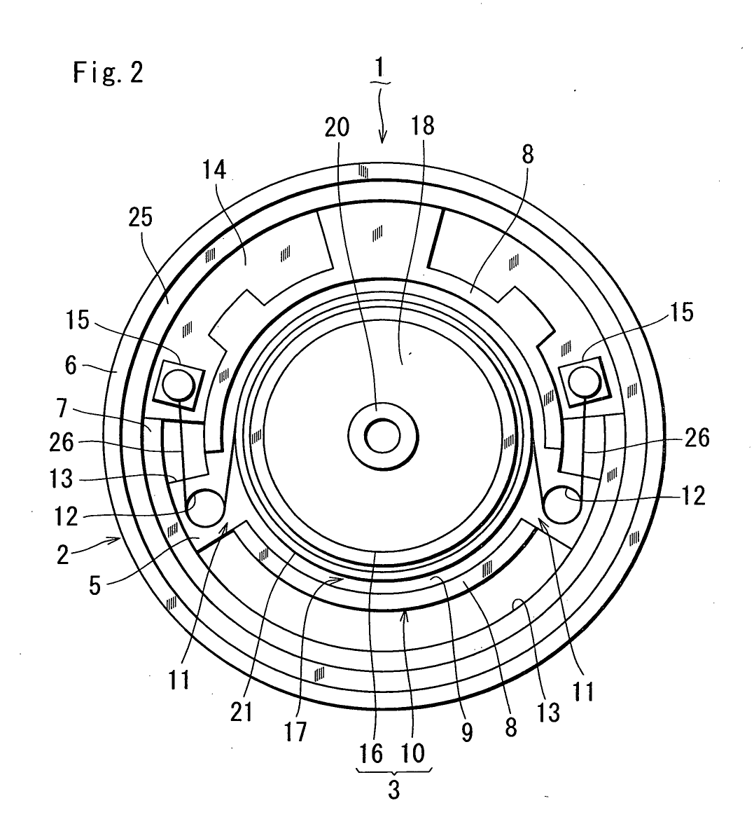

A speaker 1 shown in FIGS. 1 and 2 is configured by a yoke-integral type frame 2 made of a magnetic material, a magnetic circuit 3, and a vibration system 4.

The frame 2 is formed into a low-profile bottomed tubular shape, and has a circular bottom plate 5 and an outer wall 6 which is raised from the outer peripheral edge of the bottom plate 5. In the outer wall 6, a horizontal step face 7 is disposed, and the step face 7 causes the diameter of the upper portion of the outer wall 6 to be larger than that of the lower portion.

A yoke sidewall 8 which is an inner wall opposed to the lower portion of the outer wall 6 across a predetermined space is raised from the bottom plate 5. The yoke sidewall 8, and a circular yoke bottom plate 9 configured by a middle portion of the bottom plate 5 which is inside the yoke sidewalls 8 form a bottomed tubular yoke 10 which is lower in height than the frame 2.

A pair of lead-wire drawn out ports 11 which notch the yoke sidewall 8 to the lower end are disposed in two right and left places of the yoke sidewall 8, respectively. A pair of circular holes 12 for inserting lead-wire forming jigs are disposed in portions of the bottom plate 5 which are at lead-wire drawn out positions on the bottom portion side, and a pair of rear sound holes 13 which are substantially semi-arcuate are disposed in portions of the bottom plate 5 which are in the outer side portion of the bottom plate 5 between the outer wall 6 and the yoke sidewall 8, and which are on the bottom portion side other than the lead-wire drawn out positions. The rear sound hole 13 which is in the upper side in FIG. 2 is opened in the bottom plate 5 continuously with the lower portion of the outer wall 6 and the step face 7.

An insulative terminal plate 14 which is substantially semi-arcuate, and in which the inner peripheral edge butts against the yoke sidewall 8 is fixed to the rear side of the step face 7 which is opened by the rear sound hole 13 that is in the upper side in FIG. 2. A pair of external connection terminals (not shown) are attached to the back face side of the speaker 1 through the terminal plate 14. A pair of lead-wire contact pads 15 which are conductive with the external connection terminals are exposedly formed on the surfaces of both end portions of the terminal plate 14. The lead-wire contact pads 15 are exposed into the frame 2 through the rear sound hole 13 which is in the upper side in FIG. 2.

The magnetic circuit 3 is configured by a plastic magnet 16 and the yoke 10.

The plastic magnet 16 is molded into a columnar shape which has a substantially same height as the yoke sidewall 8, and an outer diameter which is slightly smaller than the inner diameter of the yoke sidewall 8. The plastic magnet is concentrically placed on the yoke bottom plate 9, and the upper outer peripheral face of the plastic magnet 16 is opposed to the upper inner peripheral face of the yoke sidewall 8 across a magnetic gap 17.

By taking advantage of the characteristics of the plastic magnet 16 that the magnet can be easily processed into a desired shape, the plastic magnet 16 is molded into a T-like section shape so that the diameter of the upper portion is larger than that of the lower portion. Therefore, the distance of the upper portion of the plastic magnet 16 to the yoke sidewall 8 is shorter than that of the lower portion so that magnetic fluxes are concentrated into the magnetic gap 17. Namely, the upper portion of the plastic magnet 16 plays a role of a pole piece. As compared with a conventional magnetic circuit having the three-piece structure, therefore, the magnet which occupies a smaller space, and which has a larger volume can be used. The magnetic circuit 2, which conventionally has the three-piece structure, is configured by a two-piece structure, i.e., the number of components is reduced while the driving force of a voice coil 21 which will be described later is enhanced.

In order to realize further thinning of the speaker 1, the top face (upper face) of the plastic magnet 16 is not formed as a flat face, but formed as a concave face 18 having an inverted dome-like shape.

In order to couple the plastic magnet 16 with the yoke 10 without using an adhesive agent, the following configuration is employed. A circular through hole 19 which vertically passes through the plastic magnet 16 is disposed in a center portion of the plastic magnet. By contrast, a tubular portion 20 is raised from a center portion of the yoke bottom plate 9 by a burling process. When the plastic magnet 16 is to be attached to the yoke 10, the tubular portion 20 is fitted from the lower side into the through hole 19, a tip end portion of the tubular portion 20 is upward projected from the center portion (deepest portion) of the concave face 18 of the plastic magnet 16, and a collapsing process is applied on the tip end portion of the tubular portion 20, thereby integrally coupling the plastic magnet 16 with the yoke 10.

The vibration system 4 is configured by: the voice coil 21 which is formed by winding a conductor wire around a cylindrical voice coil bobbin made of a metal or plastic film; and a circular diaphragm 22 which is made of a metal or plastic film, and which is concentrically bonded to an upper portion of the voice coil 21.

In order to realize further thinning of the speaker 1, the diaphragm 22 is formed into an inverted dome-like shape in which a middle portion of the voice coil 21 that is inside the bonded position is downward inflated, instead of a dome-like shape in which the middle portion is upward inflated.

The rear face of the outer peripheral edge of an annular edge portion 24 of the diaphragm 22 which surrounds the inverted dome portion 23 is bonded and fixed to the step face 7 of the outer wall 6 which is in the outer side of the frame 2, via a diaphragm ring 25 having an L-like section shape, so that the voice coil 21 is placed so as to be vertically movable in the magnetic gap 17 of the magnetic circuit 3.

Lead wires 26 which are drawn out from the winding start and end terminals of the voice coil 21 are drawn out to the outside of the yoke 10 through the lead-wire drawn out ports 11, respectively. Then, the lead wires are taken around the rod-like forming jigs which are inserted to the lead-wire drawn out positions through the circular holes 12 from the lower side of the frame 2, to be bent into a substantially U-like shape (forming), and guided to the lead-wire contact pads 15 to which the lead wires are to be connected. Thereafter, the tip ends of the lead wires 26 are spot-welded to the lead-wire contact pads 15 to which the lead wires are to be connected.

In the thus configured speaker 1, when an audio signal is supplied from an external circuit to the voice coil 21 through the pair of external connection terminals, the interaction between the magnetic field generated in the magnetic circuit 3 and the current flowing through the voice coil 21 causes the voice coil 21 to vertically vibrate, and, in accordance with this, the diaphragm 22 is vertically vibrated to cause the surrounding air to vibrate, thereby generating a sound.

In this case, the magnetic circuit 3 is configured by the plastic magnet 16 having a T-like section shape, and the yoke 10 which is continuously disposed in the bottom portion side and periphery of the plastic magnet 16, and therefore the number of components of the magnetic circuit, which conventionally has the three-piece structure, is reduced, whereby the mass productivity of a small and thin speaker can be enhanced.

The top face of the plastic magnet 16 is formed as the concave face 18, and the middle portion of the diaphragm 22 is formed into the inverted dome-like shape. Therefore, a sufficient amplitude can be ensured in the vibration system 4, and further thinning of a small and thin speaker can be realized without impairing the acoustic performance.

Furthermore, the tubular portion 20 which is raised from the yoke 10 on the bottom portion side of the plastic magnet 16, by a burling process, and the through hole 19 through which the tubular portion 20 is to be passed to the center portion of the plastic magnet 16 are disposed, and the plastic magnet 16 is coupled with the yoke 10 by applying a collapsing process on the tip end portion of the tubular portion 20. Therefore, the magnetic circuit 3 can be assembled without using an adhesive agent, and the mass productivity of a small and thin speaker can be further enhanced.

Although the embodiment of the invention has been described by exemplifying the round speaker 1, the speaker of the invention may be of the square type. The invention is not restricted to the embodiment, and may be variously modified without departing the spirit of the invention.

### DESCRIPTION OF REFERENCE NUMERALS

1 speaker
2 frame
3 magnetic circuit
4 vibration system
10 yoke
16 plastic magnet
17 magnetic gap
18 concave face
19 through hole
20 tubular portion
21 voice coil
22 diaphragm
23 inverted dome portion

What is claimed is:

1. A speaker comprising: a magnetic circuit; a vibration system in which a diaphragm is attached to a voice coil; and a frame which supports said magnetic circuit and said vibration system, said voice coil being placed in a magnetic gap, wherein said magnetic circuit is configured by: a plastic magnet having a T-like section shape; and a yoke which is continuously disposed in a bottom portion side and periphery of said plastic magnet.

2. A speaker according to claim 1, wherein a top face of said plastic magnet is formed as a concave face, and a middle portion of said diaphragm is formed into an inverted dome-like shape.

3. A speaker according to claim 1, wherein a tubular portion which is raised from said yoke on the bottom portion side of said plastic magnet, by a burling process, and a through hole through which said tubular portion is to be passed to a center portion of said plastic magnet are disposed, and said plastic magnet is coupled with said yoke by applying a collapsing process on a tip end portion of said tubular portion.
